(19) United States
(12) Patent Application Publication
(10) Pub. No.: US 2026/0267148 A1
(43) Pub. Date: Sep. 10, 2026

(54) OPTICAL MODULE AND ELECTRONIC DEVICE INCLUDING THE SAME

(71) Applicants: Samsung Display Co., LTD., Yongin-si (KR); Kyungpook National University Industry-Academic Cooperation Foundation, Daegu (KR)

(72) Inventors: SANG-HO KIM, Yongin-si (KR); Hak-Rin Kim, Daegu (KR); JUHWA HA, Yongin-si (KR); Jin-Hyeok Seo, Daegu (KR)

(21) Appl. No.: 19/543,367

(22) Filed: Feb. 18, 2026

(30) Foreign Application Priority Data
Mar. 6, 2025 (KR) 10-2025-0029260

(51) Int. Cl. G02B 27/01; G02B 27/00; G02B 27/28

(52) U.S. Cl. CPC G02B 27/0172; G02B 27/0068; G02B 27/283; G02B 27/286; G02B 2027/011

(57) ABSTRACT

An optical module includes a lens array including a plurality of unit lenses. Each of the unit lenses has a lens pattern. The optical module further includes a polarization controller spaced apart from the lens array in one direction. The lens array converts an incident light into a circular polarization and guides the circular polarization to the lens array. A center of lens pattern is spaced apart from a center of each of the unit lenses.

This application claims priority to Korean Patent Application No. 10-2025-0029260, filed on Mar. 6, 2025, and all the benefits accruing therefrom under 35 U.S.C. § 119, the contents of which in their entirety are incorporated herein by reference.

### BACKGROUND

### 1. Field

Embodiments relate to an optical module and an electronic device including the same. More particularly, the embodiments relate to the optical module using a geometry phase lens and the electronic device including the same.

### 2. Description of the Related Art

An electronic device that provides users with an augmented reality (AR) screen, a virtual reality (“VR”) screen, and the like. may have wearable forms such as a head mount and glasses. Accordingly, it is essential for these electronic devices for AR and VR to provide the users with a clear screen by implementing high resolution and securing focal length.

### SUMMARY

In order to provide the users with the clear screen, research is being conducted on applying an optical lens such as foveated rendering, meta lenses, and a geometric phase lens to the electronic device by tracking the user's gaze to display a high-resolution screen in the user's foveal vision area and a low-resolution screen in the peripheral vision area. Embodiments provide an optical module with an improved light control efficiency.

Embodiments provide an electronic device including the optical module.

An optical module device according to an embodiment includes a lens array including a plurality of unit lenses each having a lens pattern, wherein a center of lens pattern is spaced apart from a center of each of the unit lenses and a polarization controller spaced apart from the lens array in one direction, which converts an incident light into a circular polarization and which guides the circular polarization to the lens array.

In an embodiment, the plurality of unit lenses may include a first unit lens having a first lens pattern, a second unit lens located from the first unit lens in a first direction, and having a second lens pattern, a third unit lens located from the first unit lens in a second direction crossing the first direction, and having a third lens pattern, and a fourth unit lens located from the second unit lens in the second direction, and having a fourth lens pattern. A size of a virtual plane has a corner as a center of the first lens pattern, a center of the second lens pattern, a center of the third lens pattern, and a center of the fourth lens pattern that may be less than a size of a virtual plane having a corner as a center of the first unit lens, a center of the second unit lens, a center of the third unit lens, and a center of the fourth unit lens.

In an embodiment, the center of the first lens pattern may be spaced apart from the center of the first unit lens in a diagonal direction between the first direction and the second direction. The center of the second lens pattern may be spaced apart from the center of the second unit lens in a diagonal direction between an opposite direction of the first direction and the second direction. The center of the third lens pattern may be spaced apart from the center of the third unit lens in a diagonal direction between the first direction and an opposite direction of the second direction. The center of the fourth lens pattern may be spaced apart from the center of the fourth unit lens in a diagonal direction between the opposite direction of first direction and the opposite direction of the second direction.

In an embodiment, each of the unit lenses may be a geometric phase lens.

An electronic device according to an embodiment includes a display module including a plurality of pixels which generates an image by emitting light and an optical module which controls the light emitted from the plurality of pixels. The optical module includes a lens array which refracts the light emitted from the plurality of pixels such that two images generated from two adjacent pixels among the plurality of pixels are partially overlapped and visible to a user, and a first polarization controller disposed between the display module and the lens array, and which polarizes the light emitted from the plurality of pixels.

In an embodiment, the lens array may include a plurality of unit lenses each having a lens pattern, and a center of the lens pattern may be spaced apart from a center of each of the unit lens in a plan view.

In an embodiment, the plurality of unit lenses may include a first unit lens having a first lens pattern, a second unit lens located in a first direction from the first unit lens and having a second lens pattern, a third unit lens located in a second direction crossing the first direction from the first unit lens and having a third lens pattern, and a fourth unit lens located in the second direction from the second unit lens and having a fourth lens pattern. The plurality of pixels may include a first pixel corresponding to the first unit lens, a second pixel located in the first direction from the first pixel and corresponding to the second unit lens, a third pixel located in the second direction intersecting the first direction from the first pixel and corresponding to the third unit lens, and a fourth pixel located in the second direction from the second pixel and corresponding to the fourth unit lens. A size of a virtual plane has a corner as a center of the first lens pattern, a center of the second lens pattern, a center of the third lens pattern, and a center of the fourth lens pattern may be less than a size of a virtual plane having a corner as a center of the first unit lens, a center of the second unit lens, a center of the third unit lens, and a center of the fourth unit lens.

In an embodiment, at least two images among a first image generated from the first pixel, a second image generated from the second pixel, a third image generated from the third pixel, and a fourth image generated from the fourth pixel may be overlapped with each other through the lens array and visible to the user.

In an embodiment, the first polarization controller may include a first lens part which converts the light emitted from the plurality of pixels into a linearly polarized state, a phase retardation part which retards a phase of the linearly polarized light, and a second lens part reflects light transmitted through the phase retardation part and has a convex curved shape with a center facing the lens array, in a cross-sectional view.

In an embodiment, the light transmitted through the first polarization controller may be in a circularly polarized state.

In an embodiment, the first lens part is a polarizing beam splitter (PBS), and the second lens part may be a beam splitter (BS).

In an embodiment, the electronic device may further include a second polarization controller disposed between the first polarization controller and the lens array. And the second polarization controller may retards a phase of the light transmitted through the first polarization controller by half a wavelength.

In an embodiment, the optical module may further include a lens structure disposed between the first polarization controller and the lens array. The lens structure may include a first lens part on which light transmitted through the first polarization controller is incident, a phase retardation part which retards a phase of the light transmitted through the first lens part, and a second lens part reflects or guide the light transmitted through the phase retardation part and has a convex curved shape with a center facing the lens array, in a cross-sectional view.

In an embodiment, the light transmitted through the lens structure may be in a linearly polarized state.

In an embodiment, the optical module may further include a second polarization controller disposed between the lens structure and the lens array. The first polarization controller may convert the light emitted from the display module into a circularly polarized state. The second polarization controller may convert the linearly polarized light transmitted through the lens structure into a circularly polarized state.

In an embodiment, the second polarization controller may retard a phase of the light transmitted through the lens structure by a quarter wavelength.

In an embodiment, the first lens part may be a beam splitter (BS), and the second lens part is a polarizing beam splitter (PBS).

In an embodiment, the optical module may further include a light separator which guides the light emitted from the plurality of pixels and transmitted through the lens array to the user. The light separator may guide the representing a virtual world image and transmit through the lens array and an external light representing a real world image to the user.

In an embodiment, the lens array may have a concave curved shape with a center facing the display module, in a cross-sectional view.

In an embodiment, the lens array may have a convex curved shape with a center facing the display module, in a cross-sectional view.

In an optical module according to embodiments of the present disclosure, since a center of a lens pattern of a lens array does not coincide with a center of a unit lens, light may be converged such that adjacent images are partially overlapped with each other. Accordingly, through the light transmitted through the optical module, a user may view a high-resolution image through an area where the images are overlapped.

In an electronic device according to embodiments of the present disclosure, light emitted from the display module is incident on the lens array to provide a high-resolution image to a central vision area of the user and to provide a relatively low-resolution image to a peripheral vision area. Accordingly, the electronic device may continuously display a high-resolution screen in the central vision area of the user without a high-speed frame implementation method or an eye tracker that tracks the user's gaze. In addition, since a high-resolution screen may be displayed in the central vision area of the user by using a single display module without a screen division, the electronic device with reduced weight and shortened manufacturing cost and time may be provided.

### BRIEF DESCRIPTION OF THE DRAWINGS

Illustrative, non-limiting embodiments will be more clearly understood from the following detailed description in conjunction with the accompanying drawings.

FIG. 1 is a plan view illustrating a lens array according to an embodiment of the disclosure.

FIG. 2 is a plan view illustrating one unit lens included in the lens array of FIG. 1.

FIG. 3 is a view for explaining light convergence by the unit lens of FIG. 2.

FIG. 4 is a view for explaining light diffusion by the unit lens of FIG. 2.

FIG. 5 is a block diagram illustrating an electronic device including the lens array of FIG. 1.

FIG. 6 is a view illustrating an example of a display module and an optical module included in the electronic device of FIG. 5.

FIG. 7 is a plan view illustrating the display module of FIG. 5.

FIG. 8 is a view for explaining an example of an image visible through light transmitted through the lens array of FIG. 6.

FIG. 9 is a view illustrating an image visible to a user at the eye box of FIG. 8.

FIG. 10 is a view for explaining another example of an image visible through light transmitted through the lens array of FIG. 6.

FIG. 11 is a view illustrating an image visible to a user at the eye box of FIG. 10.

FIG. 12 is a view illustrating another example of the display module and the optical module included in the electronic device of FIG. 5.

FIG. 13 is a view illustrating still another example of the display module and the optical module included in the electronic device of FIG. 5.

FIG. 14 is a view illustrating still another example of the display module and the optical module included in the electronic device of FIG. 5.

FIG. 15 is a view illustrating still another example of the display module and the optical module included in the electronic device of FIG. 5.

FIG. 16 is a view illustrating still another example of the display module and the optical module included in the electronic device of FIG. 5.

FIG. 17 is a view illustrating still another example of the display module and the optical module included in the electronic device of FIG. 5.

FIG. 18 is a view illustrating still another example of the display module and the optical module included in the electronic device of FIG. 5.

FIG. 19 is a view illustrating still another example of the display module and the optical module included in the electronic device of FIG. 5.

FIG. 20 is a view illustrating still another example of the display module and the optical module included in the electronic device of FIG. 5.

FIG. 21 is a view illustrating still another example of the display module and the optical module included in the electronic device of FIG. 5.

FIG. 22 is a view illustrating an example in which the electronic device of FIG. 5 is implemented.

FIG. 23 is a view illustrating another example in which the electronic device of FIG. 5 is implemented.

### DETAILED DESCRIPTION OF THE EMBODIMENTS

Hereinafter, display devices in accordance with embodiments will be described in more detail with reference to the accompanying drawings. The same reference numerals are used for the same components in the drawings, and redundant descriptions of the same components will be omitted.

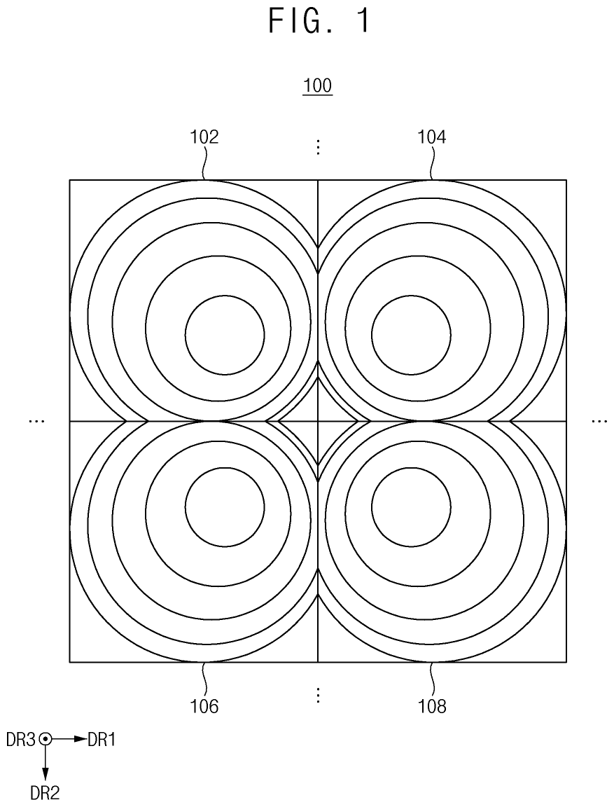

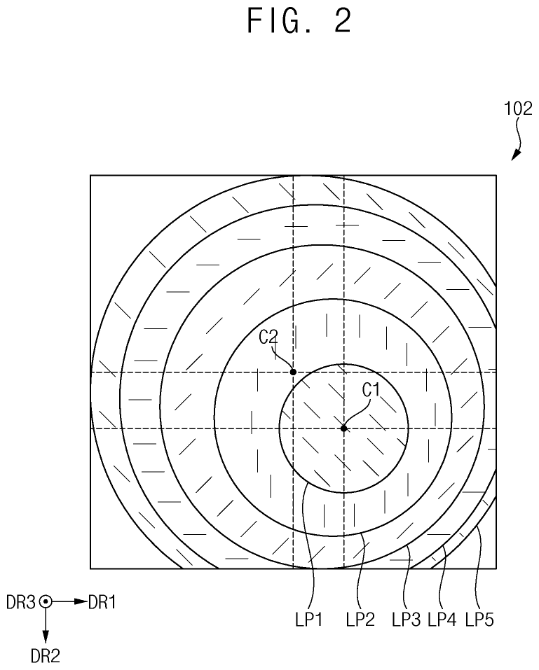

FIG. 1 is a plan view illustrating a lens array according to an embodiment of the disclosure. FIG. 2 is a plan view illustrating one unit lens included in the lens array of FIG. 1.

In the present disclosure, a plane may be defined by a first direction DR1 and a second direction DR2 crossing the first direction DR1. For example, the second direction DR2 may be perpendicular to the first direction DR1. In addition, a third direction DR3 may be perpendicular to the plane.

Referring to FIGS. 1 and 2, a lens array 100 according to an embodiment of the present disclosure may include a plurality of unit lenses. The unit lenses may be arranged along the first direction DR1 and the second direction DR2. For example, the unit lenses may be arranged in a matrix form on one surface of the lens array 100. In an embodiment, the one surface of the lens array 100 on which the unit lenses are arranged may be substantially flat. In another embodiment, the one surface of the lens array 100 on which the unit lenses are arranged may be a curved surface having curvature.

Each of the unit lenses may have a lens pattern. In an embodiment, the lens pattern may have a structure in which a plurality of light alignment materials arranged in a specific direction in a plan view are aligned. For example, the light alignment materials may be aligned in a direction that rotates away from a first center C1 with respect to the first center C1.

In an embodiment, the lens pattern may include a plurality of unit lens patterns. For example, a first lens pattern of a first unit lens 102 may include a first unit lens pattern LP1, a second unit lens pattern LP2, a third unit lens pattern LP3, a fourth unit lens pattern LP4, and a fifth unit lens pattern LP5.

A center of the lens pattern may refer to a center of a unit lens pattern located innermost within the lens pattern among unit lens patterns included in the lens pattern. For example, the center of the lens pattern of the first unit lens 102 may refer to the center of the lens pattern LP1 located innermost. In other words, the center of the lens pattern may be defined as the center of a circle of the unit lens pattern having a circular shape and located innermost within the lens pattern.

In an embodiment, the light alignment materials of the first unit lens pattern LP1 may be aligned in a diagonal direction between the first direction DR1 and the second direction DR2. The light alignment materials of the second unit lens pattern LP2 may be aligned in the second direction DR2. The light alignment materials of the third unit lens pattern LP3 may be aligned in a diagonal direction between the first direction DR1 and an opposite direction of the second direction DR2. The light alignment materials of the fourth unit lens pattern LP4 may be aligned in the first direction DR1. The light alignment materials of the fifth unit lens pattern LP5 may be aligned in a diagonal direction between the first direction DR1 and the second direction DR2. In an embodiment, an angle between an alignment direction of the light alignment materials arranged in the center of the first unit lens pattern LP1 and an alignment direction of the light alignment materials arranged in the center of the second unit lens pattern LP2 may be about forty-five degrees (45°). In an embodiment, an angle between an alignment direction of the light alignment materials in the center of the second unit lens pattern LP2 and an alignment direction in the center of the third unit lens pattern LP3 may be about 45°. In an embodiment, an angle between an alignment direction of the light alignment materials in the center of the third unit lens pattern LP3 and an alignment direction in the center of the fourth unit lens pattern LP4 may be about 45°. In an embodiment, an angle between an alignment direction of the light alignment materials in the center of the fourth unit lens pattern LP4 and an alignment direction in the center of the fifth unit lens pattern LP5 may be about 45°.

Specifically, the light alignment materials may be arranged while rotating in a direction away from the first center C1. For example, the light alignment materials arranged at the center of the first unit lens pattern LP1 may be arranged while rotating in a range of about 45° or less as light alignment materials go from the center of the first unit lens pattern LP1 to the center of the second unit lens pattern LP2. In addition, the light alignment materials arranged at the center of the second unit lens pattern LP2 may be arranged while rotating within a range of about 45° or less, for example, as the light alignment materials go from the center of the second unit lens pattern LP2 to the center of the third unit lens pattern LP3. In addition, the light alignment materials arranged at the center of the third unit lens pattern LP3 may be arranged while rotating within a range of about 45° or less, for example, as the light alignment materials go from the center of the third unit lens pattern LP3 to the center of the fourth unit lens pattern LP4. In addition, the light alignment materials arranged at the center of the fourth unit lens pattern LP4 may be arranged while rotating within an angular range of about 45° or less, for example, as the light alignment materials go from the center of the fourth unit lens pattern LP4 to the center of the fifth unit lens pattern LP5. However, an angle formed by the rotational direction of the light alignment materials and the alignment directions of the unit lens patterns according to the embodiments of the present disclosure may not be necessarily limited thereto.

In an embodiment, in the first unit lens 102, the light alignment materials may be arranged such that light alignment materials continuously rotate outward from the center of the first unit lens pattern LP1, through the second, third, fourth, and fifth unit lens patterns LP2, LP3, LP4, and LP5.

In an embodiment, an alignment direction of the light alignment materials of each of the first, second, third, fourth, and fifth unit lens patterns LP1, LP2, LP3, LP4, and LP5 may be an optical axis direction.

In an embodiment, the alignment direction of the light alignment materials of the first unit lens pattern LP1 may be equal to the alignment direction of the light alignment materials of the fifth unit lens pattern LP5. In an embodiment, the unit lens patterns may be regularly arranged in units of four such that the alignment directions of the light alignment materials are equal. However, the unit lens patterns according to embodiments of the present disclosure may not be limited thereto, and may be regularly arranged in units of three or less or five or more such that the alignment directions of the light alignment materials are equal.

In an embodiment, the light alignment materials in the first unit lens pattern LP1 may be arranged to form a circular shape centered on a first center C1 in a plan view. In an embodiment, the light alignment materials in the second unit lens pattern LP2 may be arranged to form a ring shape surrounding the first unit lens pattern LP1. In an embodiment, the light alignment materials in the third unit lens pattern LP3 may be arranged to form a ring shape surrounding the second unit lens pattern LP2. In an embodiment, the light alignment materials in the fourth unit lens pattern LP4 may be arranged to form a ring shape surrounding the third unit lens pattern LP3. In an embodiment, the light alignment materials in the fifth unit lens pattern LP5 may be arranged to form a ring shape surrounding the fourth unit lens pattern LP4.

In an embodiment, the center of the ring shape of the second unit lens pattern LP2 may be spaced apart from the first center C1 in a plan view. In an embodiment, the center of the ring shape of the third unit lens pattern LP3 may be spaced apart from the first center C1 in a plan view. In an embodiment, the center of the ring shape of the fourth unit lens pattern LP4 may be spaced apart from the first center C1 in a plan view. In an embodiment, the center of the ring shape of the fifth unit lens pattern LP5 may be spaced apart from the first center C1 in a plan view. In other words, the ring shape of each of the second unit lens pattern LP2, the third unit lens pattern LP3, the fourth unit lens pattern LP4, and the fifth unit lens pattern LP5 may not coincide with the first center C1, which is the center of the circular shape of the first unit lens pattern LP1.

In an embodiment, each unit lens pattern of the unit lenses may have a shape that narrows in width toward the outer side. For example, in the first unit lens 102, a radius of the first unit lens pattern LP1 may be greater than a first distance between an outer edge of the first unit lens pattern LP1 and an outer edge of the second unit lens pattern LP2. The first distance may be greater than a second distance between the outer edge of the second unit lens pattern LP2 and an outer edge of the third unit lens patterns LP3. The second distance may be greater than a third distance between the outer edge of the third unit lens pattern LP3 and an outer edge of the fourth unit lens pattern LP4. The third distance may be greater than a fourth distance between the outer edge of the fourth LP4 and an outer edge of the fifth unit lens pattern LP5. The first, second, third, and fourth distances may be defined as distances parallel to the first direction DR1, the second direction DR2, or a direction crossing the first and second directions in a plane defined by the first direction DR1 and the second direction DR2.

In an embodiment, each of the unit lenses may be a geometric phase lens. In an embodiment, each light-alignment material may include a metamaterial, a nanomaterial, or LC molecules, and they may be used individually or in combination. However, the light alignment materials according to embodiments of the present disclosure may not be limited thereto and may include various materials patterned to implement geometric phase lenses.

In an embodiment, the unit lenses included in the lens array 100 may include a first unit lens 102, a second unit lens 104, a third unit lens 106, and a fourth unit lens 108. For example, the second unit lens 104 may be located in the first direction DR1 from the first unit lens 102. The third unit lens 106 may be located in the second direction DR2 from the first unit lens 102. The fourth unit lens 108 may be located in the second direction DR2 from the second unit lens 104.

In an embodiment, the center of each of the unit lenses may be positioned differently from the center of the corresponding lens pattern. For example, the center of each unit lens may be spaced apart in a plan view from the center of the rings of the lens pattern.

In an embodiment, a first center C1, which is the center of the first lens pattern arranged in the first unit lens 102, may be spaced apart in a plan view from a second center C2, which is the center of the first unit lens 102. For example, the first center C1 may be spaced apart from the second center C2 in a diagonal direction between the first direction DR1 and the second direction DR2.

In an embodiment, a center of the second lens pattern arranged in the second unit lens 104 may be spaced apart from the center of the second unit lens 104 in a plan view. For example, the center of the second lens pattern may be spaced apart from the center of the second unit lens 104 in a diagonal direction between the opposite of the first direction DR1 and the second direction DR2.

In an embodiment, a center of the third lens pattern arranged in the third unit lens 106 may be spaced apart from the center of the third unit lens 106 in a plan view. For example, the center of the third lens pattern arranged in the third unit lens 106 may be spaced apart in a diagonal direction between the first direction DR1 and the opposite of the second direction DR2 from the center of the third unit lens 106.

In an embodiment, a center of the fourth lens pattern arranged in the third unit lens 106 may be spaced apart from the center of the fourth unit lens 108 in a plan view. For example, the center of the fourth lens pattern arranged in the fourth unit lens 108 may be spaced apart in a diagonal direction between the opposite direction of the first direction DR1 and the opposite direction of the second directions DR2 from the center of the fourth unit lens 108.

In an embodiment, a size of a virtual plane having the centers of the first lens pattern, the second lens pattern, the third lens pattern, and the fourth lens pattern as corners may be less than a size of a virtual plane having the centers of the first unit lens 102, the second unit lens 104, the third unit lens 106, and the fourth unit lens 108 as corners. For example, the virtual plane having the centers of the first lens pattern, the second lens pattern, the third lens pattern, and the fourth lens pattern as corners may be located in the virtual plane having the centers of the first unit lens 102, the second unit lens 104, the third unit lens 106, and the fourth unit lens 108 as corners. However, a locational relationship between the centers of the first lens pattern, the second lens pattern, the third lens pattern, and the fourth lens pattern and the centers of the first unit lens 102, the second unit lens 104, the third unit lens 106, and the fourth unit lens 108 may not be limited thereto.

In an embodiment, the first unit lens 102 and the second unit lens 104 may be symmetrical with respect to a virtual line parallel to the second direction DR2. In an embodiment, the third unit lens 106 and the fourth unit lens 108 may be symmetrical with respect to a virtual line parallel to the second direction DR2. In an embodiment, the first unit lens 102 and the third unit lens 106 may be symmetrical with respect to a virtual line parallel to the first direction DR1. In an embodiment, the second unit lens 104 and the fourth unit lens 108 may be symmetrical with respect to a virtual line parallel to the first direction DR1. However, a symmetrical relationship among the first unit lens 102, the second unit lens 104, the third unit lens 106, and the fourth unit lens 108 according to the embodiments of the present disclosure is not necessarily limited thereto.

In FIG. 1, an arrangement of the unit lenses included in the lens array 100 according to an embodiment of the present disclosure may be illustrated as being arranged in units of four, the arrangement of the unit lenses according to embodiments of the present disclosure may not be limited thereto, and the lens pattern in the unit lenses may be arranged in various forms in which the center of each unit lens is spaced apart in a plan view from the center of the lens pattern.

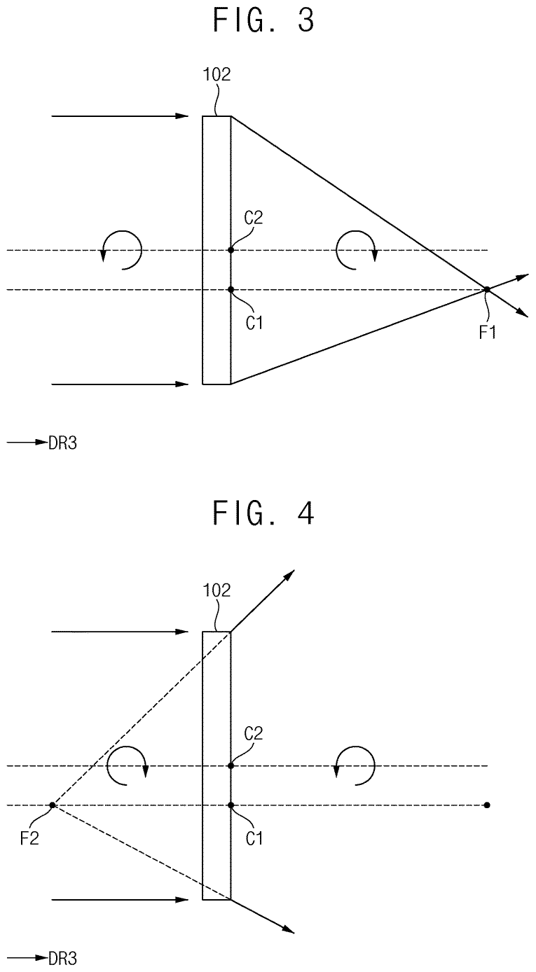

FIG. 3 is a view for explaining light convergence by the unit lens of FIG. 2. FIG. 4 is a view for explaining light diffusion by the unit lens of FIG. 2.

Referring to FIGS. 1, 2, 3, and 4, when light is incident toward the lens array 100 along the third direction DR3, the light transmitted through the lens array 100 may be converged or diffused depending on the polarization state of the light. For example, when light in a left-handed circularly polarized state is incident on the first unit lens 102, the light transmitted through the first unit lens 102 is in a right-handed circularly polarized state and may be converged toward the first focus F1. For example, when light in the right-handed circularly polarized state is incident on the first unit lens 102, the light transmitted through the first unit lens 102 is in the left-handed circularly polarized state and may be diffused with reference to the second focus F2.

However, relationships between polarization state, diffusion, and convergence according to the embodiments of the present disclosure may not be necessarily limited thereto. For example, when the photo-alignment materials arranged in the first unit lens 102 are reversely designed, or the first unit lens 102 is arranged in a flipped orientation, the light in the right-handed circularly polarized state incident on the first unit lens 102 may be transmitted through the first unit lens 102 and converged in the left-handed circularly polarized state. In addition, the light in the left-handed circularly polarized state incident on the first unit lens 102 may be transmitted through the first unit lens 102 and diffused in the right-handed circularly polarized state.

In an embodiment, a virtual line parallel to the third direction DR3 may pass through both the first focus F1 and the first center C1. In an embodiment, the virtual line parallel to the third direction DR3 may pass through both the second focus F2 and the first center C1. In other words, the first focus F1 and the second focus F2 may be located on the virtual line passing through the center of the first lens pattern of the first unit lens 102 and parallel to the third direction DR3.

In FIGS. 3 and 4, convergence and diffusion processes may be illustrated only through the first unit lens 102, however, the lens array 100 according to the embodiments of the present disclosure may not be necessarily limited thereto, and the convergence and diffusion processes may be performed through each of the plurality of unit lenses included in the lens array 100.

In an embodiment, when the light in a right-handed circularly polarized state is transmitted through the lens array 100, the light transmitted through each of two adjacent lenses among the plurality of unit lenses may overlap with reference to the boundary between the two lenses. For example, when first light generating a first image is transmitted through the first unit lens 102, and second light generating a second image is transmitted through the second unit lens 104, and both the first light and the second light are in a right-handed circularly polarized state, the first image and the second image may be partially overlapped and visually recognized due to diffusion of both the first light and the second light.

Specifically, when the light transmitted through the first unit lens 102 and the second unit lens 104 is diffused, the light transmitted through the area corresponding to the first unit lens 102 and the light transmitted through the area corresponding to the second unit lens 104 may be visually recognized in a state of overlapping in the first direction DR1 at the side or boundary where the first unit lens 102 and the second unit lens 104 cross. When the light transmitted through the first unit lens 102 and the third unit lens 106 is diffused, the light transmitted through the area corresponding to the first unit lens 102 and the light transmitted through the area corresponding to the third unit lens 106 may be visually recognized in a state of overlapping in the second direction DR2 at the side or boundary where the first unit lens 102 and the third unit lens 106 cross. When the light transmitted through the first unit lens 102 and the fourth unit lens 108 is diffused, the light transmitted through the area corresponding to the first unit lens 102 and the light transmitted through the area corresponding to the fourth unit lens 108 may be visually recognized in a state of overlapping in a diagonal direction of the first direction DR1 and the second direction DR2 at the point or boundary where the first unit lens 102 and the fourth unit lens 108 cross.

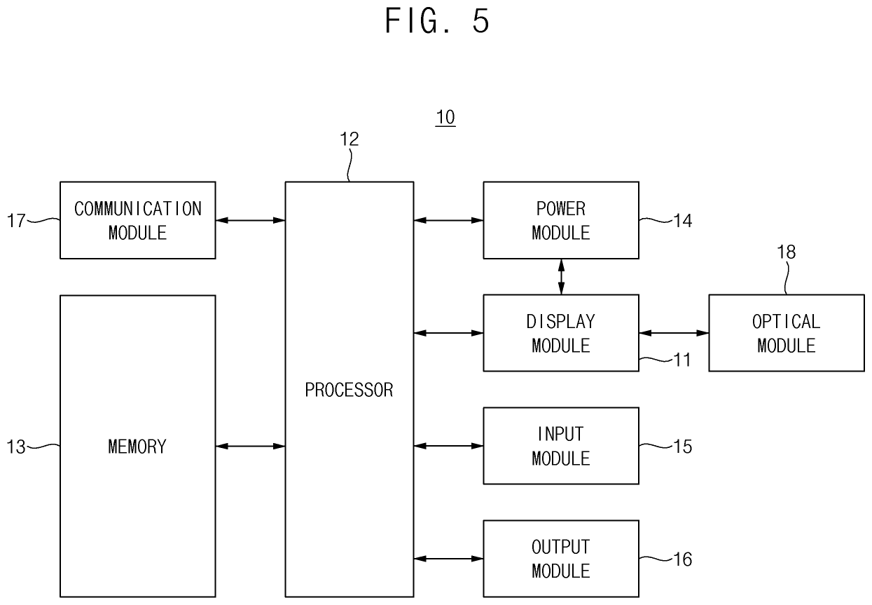

FIG. 5 is a block diagram illustrating an electronic device including the lens array of FIG. 1.

Referring to FIG. 5, an electronic device 10 may include a display module 11, a processor 12, a memory 13, and a power module 14. The electronic device 10 may further include an input module 15, a non-image output module 16, and/or a communication module 17. The electronic device 10 may further include an optical module 18.

The electronic device 10 may output various types of information in the form of images through the display module 11. For example, the display module 11 may emit light to output the image. When the processor 12 executes an application stored in the memory 13, image information provided by the application may be delivered to the user via the display module 11. The power module 14 may include a power supply module, such as, for example, a power adapter or a battery device, and a power conversion module that converts power supplied by the power supply module to generate power required for operation of the electronic device 10. The input module 15 may provide input information to the processor 12 and/or the display module 11. The non-image output module 16 may receive information other than images, such as sound, haptic feedback, and light-emitting from the processor 12 and provide the information to the user. The communication module 17 is a module that transmits and receives information between the electronic device 10 and an external device and may include a receiver and a transmitter.

The optical module 18 may control the light emitted from the display module 11 to provide a clear image to the user. For example, the optical module 18 may include various types of lenses, polarizers, and the like for controlling the light. In addition, the optical module 18 may include a light receiving unit such as a camera that receives external light.

At least one of the components of the electronic device 10 described above may be implemented to be included in the display device. Further, some of the individual modules functionally included in one module may be included in the display device, while others may be provided separately from the display device. For example, the display device may include the display module 11, and the processor 12, the memory 13, and the power module 14 may be provided as components of another device which is not a display device in the electronic device 10. However, components included in the display device according to the embodiments of the present disclosure may not be necessarily limited thereto.

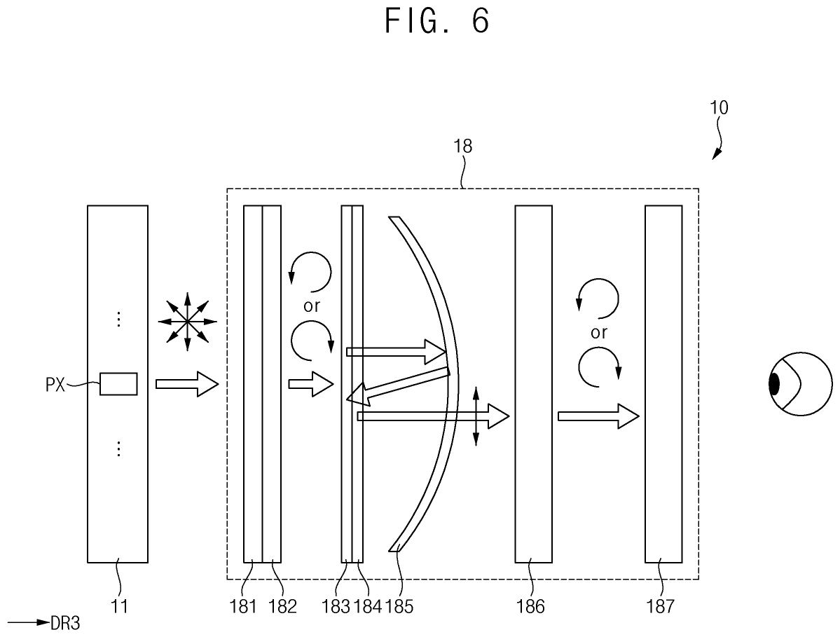

FIG. 6 is a view illustrating an example of a display module and an optical module included in the electronic device of FIG. 5.

Referring to FIG. 6, the optical module 18 may include a linear polarization part 181, a first phase retardation part 182, a first lens part 183, a second phase retardation part 184, a second lens part 185, a third phase retardation part 186, and a lens array 187. The lens array 187 may be substantially the same as the lens array 100 of FIG. 1. In an embodiment, the linear polarization part 181, the first phase retardation part 182, the first lens part 183, the second phase retardation part 184, the second lens part 185, the third phase retardation part 186, and the lens array 187 may be sequentially disposed along a third direction DR3 from the display module 11.

In the present disclosure, the linear polarization part 181 and the first phase retardation part 182 may be referred to as a first polarization controller. The first lens part 183, the second phase retardation part 184, and the second lens part 185 may be referred to as a lens structure. The third phase retardation part 186 may be referred to as a second polarization controller.

In an embodiment, the optical module 18 may be spaced apart from the display module 11 in the third direction DR3. For example, the optical module 18 may be positioned closer to the user than the display module 11. Accordingly, the optical module 18 may control the light emitted from the plurality of pixels PX of the display module 11 through polarization, convergence, diffusion, and the like.

The linear polarization part 181 may polarize the light emitted from the plurality of pixels PX into a linearly polarized state. In an embodiment, the linear polarization part 181 may be a linear polarizer that polarizes light in a direction perpendicular to the third direction DR3. For example, the linear polarization part 181 may have a transmission axis extending in a direction perpendicular to the third direction DR3 and an absorption axis perpendicular to both the transmission axis and the third direction DR3.

The first phase retardation part 182 may retard the phase of the light polarized through the linear polarization part 181. For example, the first phase retardation part 182 may convert the linearly polarized light into a circularly polarized state such as left-handed or right-handed circular polarization, or into an elliptically polarized state. In an embodiment, the first phase retardation part 182 may be a quarter wave plate (QWP). For example, the optical axis of the first phase retardation part 182 may form an angle of approximately plus or minus forty-five degrees (±45°) in a plan view with respect to the transmission axis of the linear polarization part 181.

In an embodiment, the first phase retardation part 182 may be attached to the linear polarization part 181. For example, the first phase retardation part 182 may be in the form of a film attached to the linear polarization part 181. However, the shape of the first phase retardation part 182 according to the embodiments of the present disclosure is not necessarily limited thereto.

The first lens part 183 may transmit at least a portion of the light that has been converted into a circularly polarized state by the first phase retardation part 182. For example, the first lens part 183 may be a beam splitter (BS) that transmits a portion of the light that has passed through the first phase retardation part 182 and reflects another portion of the light.

The second phase retardation part 184 may convert the circularly polarized light transmitted through the first lens part 183 into a linearly polarized state. In an embodiment, the second phase retardation part 184 may be a quarter wave plate. In an embodiment, the second phase retardation part 184 may be attached to the first lens part 183. For example, the second phase retardation part 184 may be in a form of a film attached to the first lens part 183. However, a shape of the second phase retardation part 184 according to the embodiments of the present disclosure may not be necessarily limited thereto.

The second lens part 185 may reflect a portion of the linearly polarized light transmitted through the second phase retardation part 184 back toward the second phase retardation part 184. Specifically, the light reflected by the second lens part 185 toward the second phase retardation part 184 may pass through the second phase retardation part 184, be converted into a circularly polarized state, and be incident on the first lens part 183. The light that has passed through the phase retardation part 184 may be reflected by the first lens part 183, pass again through the phase retardation part 184, and be converted into a circularly polarized state before being incident on the second lens part 185.

The second lens part 185 may absorb or transmit another portion of the linearly polarized light transmitted through the second phase retardation part 184. For example, when the transmission axis of the second phase retardation part 184 is aligned with the polarization direction of the light transmitted through the second lens part 185, the light may pass through the second phase retardation part 184. In another example, when the transmission axis of the second phase retardation part 184 is perpendicular to the polarization direction of the light transmitted through the second lens part 185, the light may be absorbed by the second phase retardation part 184. Specifically, the light that is not reflected by the second lens part 185 and passes through the second phase retardation part 184 may be absorbed by the second lens part 185, while the light that is reflected by both the first lens part 183 and the second lens part 185 and then transmitted through the second phase retardation part 184 may be transmitted through the second lens part 185.

In an embodiment, the second lens part 185 may be a polarizing beam splitter (PBS). In an embodiment, the second lens part 185 may have a convex curved shape with a center facing toward the lens array 187, in a cross-sectional view.

The third phase retardation part 186 may retard the phase of the linearly polarized light transmitted through the second lens part 185. For example, the third phase retardation part 186 may convert the linearly polarized light transmitted through the second lens part 185 into a circularly polarized state. In an embodiment, the third phase retardation part 186 may be a quarter wave plate.

The lens array 187 may diffuse the light transmitted through the third phase retardation part 186. For example, the light incident on the lens array 187 may be in a right-handed circularly polarized state. Specifically, since the light in a right-handed circularly polarized state diverges through the plurality of unit lenses of the lens array 187, the images corresponding to two adjacent lenses among the plurality of unit lenses may be visually recognized in an overlapped state. However, types of light incident on the lens array 187 according to the embodiments of the present disclosure may not be necessarily limited thereto and may be in a left-handed circularly polarized state.

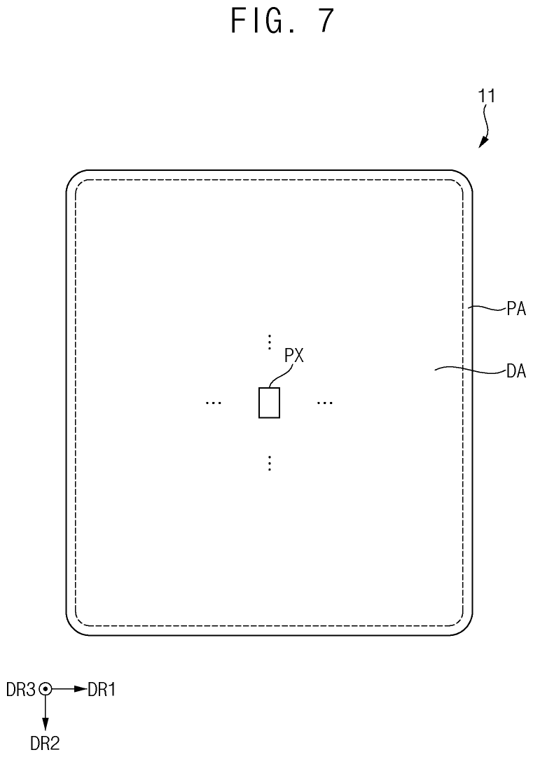

FIG. 7 is a plan view illustrating the display module of FIG. 5.

Referring to FIG. 7, the display module 11 may include a display area DA and a non-display area NDA. The display area DA may be defined as an area for generating images, and the non-display area NDA may be defined as an area that does not generate images.

A plurality of pixels PX may be arranged in the display area DA. In an embodiment, the plurality of pixels PX may be arranged in the display area DA along a first direction DR1 and a second direction DR2. For example, the plurality of pixels PX may be arranged in the form of a matrix within the display area DA.

In an embodiment, the plurality of pixels PX may include a first pixel, a second pixel, and a third pixel. For example, light of a first color may be viewed from the first pixel, light of a second color may be viewed from the second pixel, and light of a third color may be viewed from the third pixel. In an embodiment, the light of the first color may be red light, the light of the second color may be green light, and the light of the third color may be blue light. However, plurality of pixels PX according to the embodiments of the present disclosure may not be necessarily limited thereto. For example, the plurality of pixels PX may also be configured to emit yellow, cyan, and magenta light.

The non-display area NDA may be adjacent to the display area DA. For example, the non-display area NDA may surround at least a portion of the display area DA. A driver may be disposed in the non-display area NDA. The driver may provide signals or voltages to the plurality of pixels PX. For example, the driver may include, but is not limited to, a data driver, a gate driver, a power voltage generator, and a driving controller. However, the non-display area NDA according to the embodiments of the present disclosure may not be necessarily limited thereto and may include components (e.g., the plurality of pixels PX) that emit light.

In an embodiment, the display module 11 may be a micro light-emitting diode display device including micro light-emitting diodes. However, the display module 11 according to the embodiments of the present disclosure may not be necessarily limited thereto, and the display module 11 may be an organic light-emitting diode (OLED) display device including an organic light-emitting diode or a quantum dot light-emitting diode display device including a quantum dot.

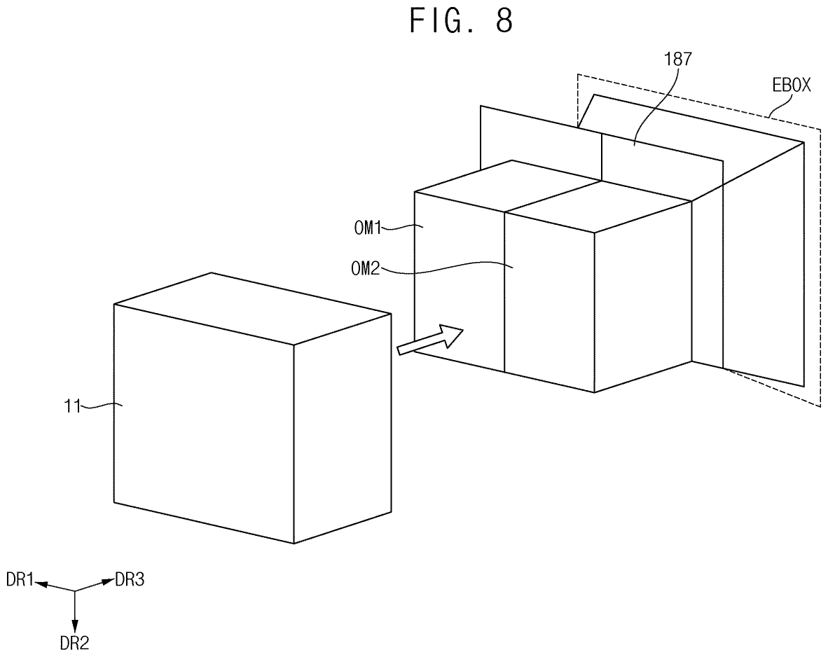

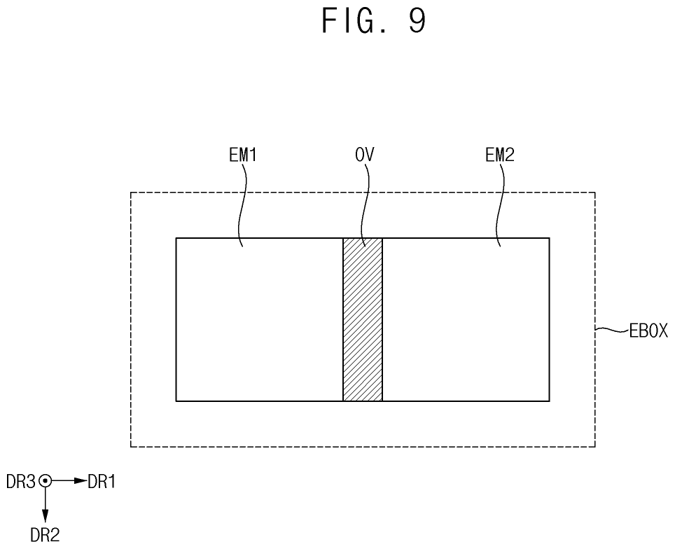

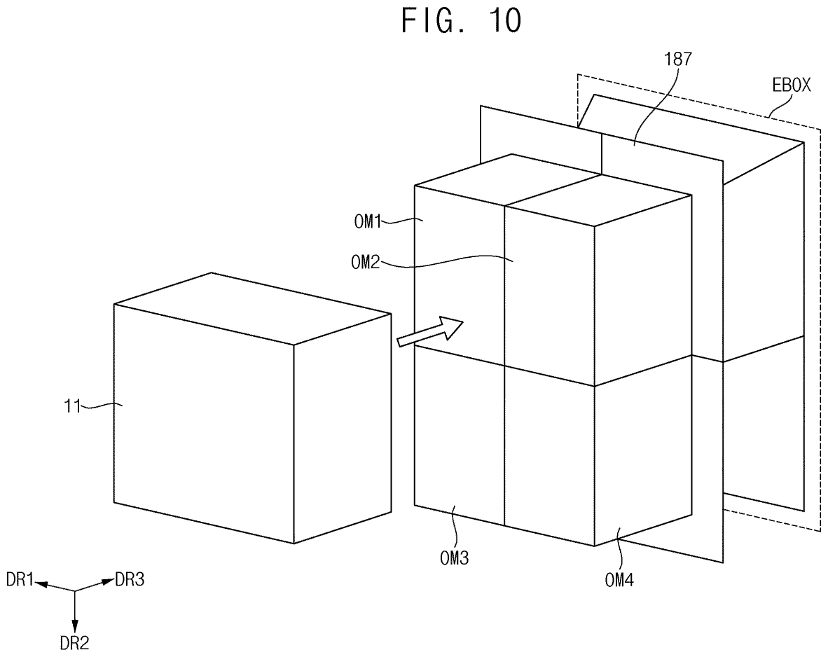

FIG. 8 is a view for explaining an example of an image visible through light transmitted through the lens array of FIG. 6. FIG. 9 is a view illustrating an image visible to a user at the eye box of FIG. 8.

Referring to FIGS. 7, 8, and 9, the plurality of pixels of the display module 11 may be divided into a first pixel group and a second pixel group adjacent to the first pixel group. One pixel among the plurality of pixels, or two or more adjacent pixels, may be defined as a single pixel group. Light emitted from the first pixel group of the display module 11 may generate a first output image OM1. Light emitted from the second pixel group of the display module 11 may form a second output image OM2.

The light corresponding to the first output image OM1 and the light corresponding to the second output image OM2 may pass through the lens array 187. For example, the light corresponding to the first output image OM1 may pass through the first unit lens 102 of FIG. 1, and the light corresponding to the second output image OM2 may pass through the second unit lens 104 of FIG. 1. Although a component between the display module 11 and the lens array 187 may not be illustrated in FIG. 8, the light corresponding to the first output image OM1 and the light corresponding to the second output image OM2 may be incident on the lens array 187 after passing through the components between the display module 11 and the lens array 187 in the electronic device according to embodiments of the present disclosure. For example, the light incident on the lens array 187 and corresponding to the first output image OM1 and the second output image OM2 may be in a circularly polarized state.

Since the light corresponding to the first output image OM1 and the light corresponding to the second output image OM2 are diffused through the lens array 187, the first output image OM1 and the second output image OM2 may be visually recognized by the user as partially overlapping. For example, within an eye box EBOX, the first output image OM1 may be perceived as a first extended image EM1, and the second output image OM2 may be perceived as a second extended image EM2. Accordingly, an overlap area OV, which is a area in which the first extended image EM1 and the second output image OM2 overlap with each other, may be perceived by the user.

The overlap area OV may be an area that provides approximately double (2×) the resolution to the user. Specifically, since the target object displayed by the display module 11 is implemented in a grid form according to the number of pixels PX included in the display module 11, when the light emitted from adjacent pixel groups partially overlaps, the target object may be effectively displayed using a relatively larger number of pixels PX.

Accordingly, since the overlap area OV is implemented at the location where the user's gaze is directed, the electronic device 10 may provide a high-resolution screen to the user's foveal vision area and a relatively low-resolution image to the peripheral vision area without including a high-speed frame rendering method for foveated rendering or an eye tracker that tracks the user's gaze. In addition, the electronic device 10 according to the embodiments of the present disclosure may not require two or more display modules for screen division to implement foveated rendering, and since a high-resolution screen may be displayed in the user's foveal vision area using a single display module 11, a lightweight and cost-effective electronic device 10 with reduced manufacturing time may be provided. Furthermore, the lens array 187 may be manufactured in the form of a lightweight, ultra-thin film, so the lens array 187 may be formed on a curved surface of the display module 11.

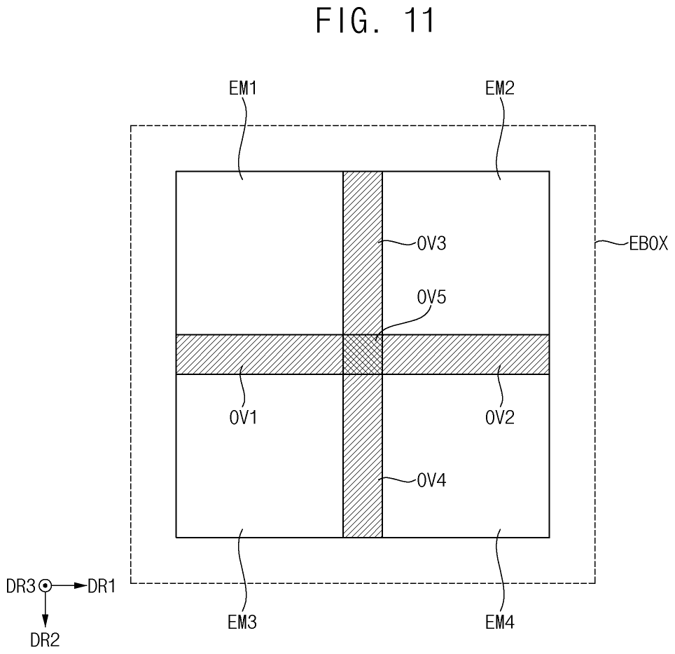

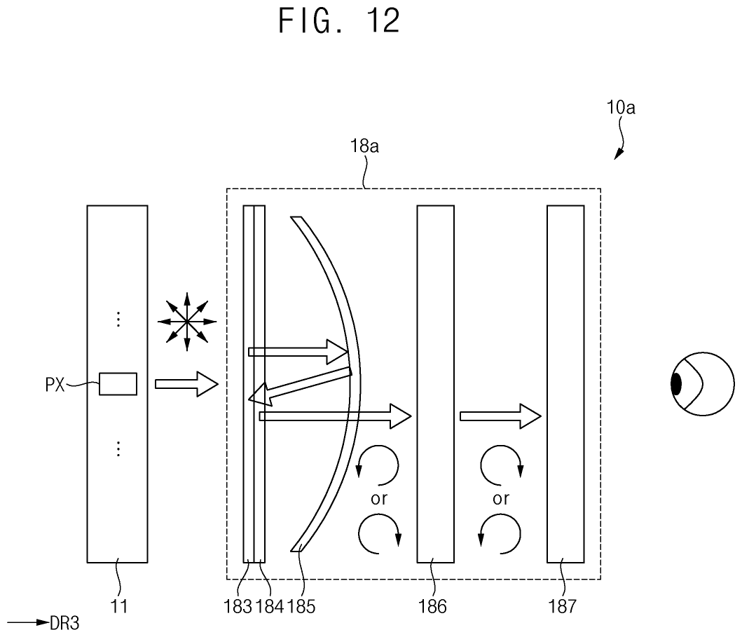

FIG. 10 is a view for explaining another example of an image visible through light transmitted through the lens array of FIG. 6. FIG. 11 is a view illustrating an image visible to a user at the eye box of FIG. 10.

Referring to FIGS. 10 and 11, the plurality of pixels of the display module 11 may be divided into a first pixel group, a second pixel group, a third pixel group, and a fourth pixel group, each adjacent to one another. Light emitted from the first pixel group of the display module 11 may generate a first output image OM1. Light emitted from the second pixel group of the display module 11 may form a second output image OM2. Light emitted from the third pixel group of the display module 11 may form a third output image OM3. Light emitted from the fourth pixel group of the display module 11 may form a fourth output image OM4.

The light corresponding to the first output image OM1, the second output image OM2, the third output image OM3, and the fourth output image OM4 may pass through the lens array 187. For example, the light corresponding to the first output image OM1 may pass through the first unit lens 102 of FIG. 1. In addition, the light corresponding to the second output image OM2 may pass through the second unit lens 104 of FIG. 1. In addition, the light corresponding to the third output image OM3 may pass through the third unit lens 106 of FIG. 1. In addition, the light corresponding to the fourth output image OM4 may pass through the fourth unit lens 108 of FIG. 1.

Although the component between the display module 11 and the lens array 187 is not shown in FIG. 10, the light corresponding to the first output image OM1, the light corresponding to the second output image OM2, the light corresponding to the third output image OM3, and the light corresponding to the fourth output image OM4 may be incident on the lens array 187 after passing through components disposed between the display module 11 and the lens array 187 in the electronic device according to embodiments of the present disclosure. For example, the light incident on the lens array 187 and corresponding to the first output image OM1, the second output image OM2, the third output image OM3, and the fourth output image OM4 may be in a circularly polarized state.

Since the light corresponding to the first output image OM1, the second output image OM2, the third output image OM3, and the fourth output image OM4 is diffused through the lens array 187, the first output image OM1, the second output image OM2, the third output image OM3, and the fourth output image OM4 may be partially overlapped and visually recognized by the user. For example, the first output image OM1 may be visually recognized as a first extended image EM1 in the eye box EBOX. In addition, the second output image OM2 may be visually recognized as a second extended image EM2 in the eye box EBOX. In addition, the third output image OM3 may be visually recognized as a third extended image EM3 in the eye box EBOX. In addition, the fourth output image OM4 may be visually recognized as a fourth extended image EM4 in the eye box EBOX.

A first overlap area OV1, where the first extended image EM1 and the third output image OM3 overlap with each other in the second direction DR2, may be visually recognized by the user. A second overlap area OV2, where the first extended image EM2 and the fourth output image OM4 overlap with each other in the second direction DR2, may be visually recognized by the user. A third overlap area OV3, where the first extended image EM2 and the second output image OM2 overlap with each other in the first direction DR1, may be visually recognized by the user. A fourth overlap area OV4, where the third extended image EM3 and the fourth output image OM4 overlap with each other in the first direction DR1, may be visually recognized by the user. A fifth overlap area OV5, where the first extended image EM1, the second extended image EM2, the third extended image EM3, and the fourth extended image EM4 all overlap, may be visually recognized by the user.

The first overlap area OV1, the second overlap area OV2, the third overlap area OV3, and the fourth overlap area OV4 may be areas that provide approximately double resolution to the user. In addition, since four images are overlapped in the fifth overlap area OV5, the fifth overlap area OV5 may be an area that provides approximately four times the resolution to the user. Specifically, since the target object displayed on the display module 11 is implemented in the form of a grid according to the number of pixels PX included in the display module 11, when the light emitted from adjacent pixel groups partially overlaps, the target object may be displayed using a relatively larger number of pixels PX.

As described above, in FIGS. 8 and 9, the high-resolution implementation process has been described using two pixel groups, and in FIGS. 10 and 11, the high-resolution implementation process has been described using four pixel groups. However, a number of pixel groups, a number of output images, a number of extended images, and a number of overlap areas described with reference to FIGS. 8, 9, 10, and 11 may be merely exemplary. The electronic device 10 according to the embodiments of the present disclosure may not be necessarily limited thereto. In other words, the number of pixel groups, the number of output images, the number of extended images, and the number of overlap areas may vary depending on the arrangement of the plurality of unit lenses of the lens array for focusing light.

As described above with reference to FIGS. 1, 2, 3, 4, 5, 6, 7, 8, 9, 10, and 11 (collectively referred to as FIGS. 1-11), in the optical module 18, since the center of the lens pattern of the lens array 100 and 187 does not coincide with the center of the unit lens, the light may be focused such that adjacent images are partially overlapped with each other. Accordingly, the user may view a high-resolution image through the overlapping area of the images from the light transmitted through the optical module 18.

FIG. 12 is a view illustrating another example of the display module and the optical module included in the electronic device of FIG. 5.

The electronic device 10a described with reference to FIG. 12 may be substantially a same or similar in structure to the electronic device 10 described with reference to FIG. 6, except that no component for polarization is disposed between the display module 11 and the first lens part 183, and the state of light passing through the second lens part 185 is different.

Hereinafter, contents overlapping with the description with reference to FIG. 6 may be omitted or briefly described.

Referring to FIG. 12, the electronic device 10a may include an optical module 18a. The optical module 18a may include the first lens part 183, the second phase retardation part 184, the second lens part 185, the third phase retardation part 186, and the lens array 187. In other words, the optical module 18a may not include the linear polarization part 181 and the first phase retardation part 182 of FIG. 6. In an embodiment, the first lens part 183, the second phase retardation part 184, the second lens part 185, the third phase retardation part 186, and the lens array 187 may be sequentially disposed along the third direction DR3 from the display module 11.

In the present disclosure, the first lens part 183, the second phase retardation part 184, and the second lens part 185 may be referred to as a first polarization controller.

The first lens part 183 may polarize the light emitted from the plurality of pixels PX into a linearly polarized state. In an embodiment, the first lens part 183 may be a polarizing beam splitter.

The second phase retardation part 184 may convert the linearly polarized light that has passed through the first lens part 183 into a circularly polarized state. In an embodiment, the second phase retardation part 184 may be a quarter-wave plate.

The second lens part 185 may reflect a portion of the circularly polarized light that has passed through the second phase retardation part 184 back toward the second phase retardation part 184. In an embodiment, the second lens part 185 may be a beam splitter.

The circularly polarized light reflected by the second lens part 185 may pass through the second phase retardation part 184 and be converted into a linearly polarized state, and may be reflected by the first lens part 183 to be incident again toward the second phase retardation part 184. The linearly polarized light reflected by the first lens part 183 may become circularly polarized and may pass through the second lens part 185.

In an embodiment, the third phase retardation part 186 may be disposed between the second lens part 185 and the lens array 187. The third phase retardation part 186 may retard the phase of the circularly polarized light that has passed through the second lens part 185. For example, the circularly polarized light that has passed through the second lens part 185 may pass through the third phase retardation part 186 and the direction of the optical axis may be rotated by about 90°.

In an embodiment, the third phase retardation part 186 may be a half wave plate HWP. Accordingly, circularly polarized light may be incident on the lens array 187. For example, the light incident on the lens array 187 may be in the right-handed circular polarization state. In other words, the third phase retardation part 186 may serve to rotate the optical axis so that the light incident on the lens array 187 is scattered after passing through the lens array 187. However, the type of light incident on the lens array 187 according to embodiments of the present disclosure may not be necessarily limited thereto and may also be in the left-handed circular polarization state.

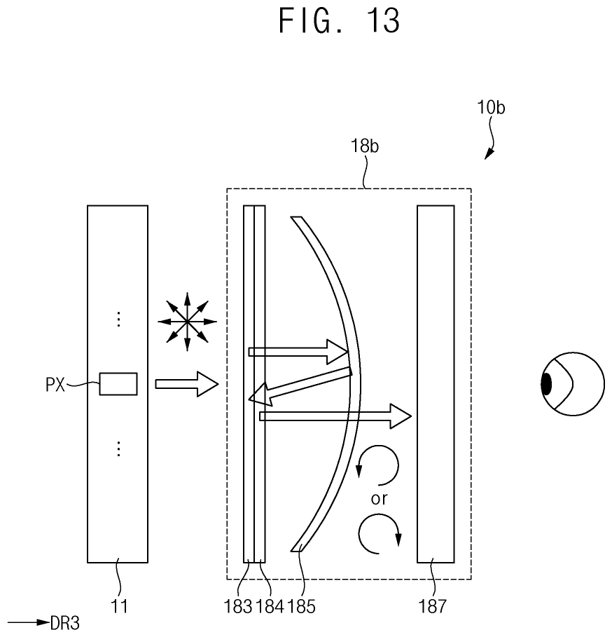

FIG. 13 is a view illustrating still another example of the display module and the optical module included in the electronic device of FIG. 5.

The electronic device 10b described with reference to FIG. 13 may be substantially a same or similar in structure to the electronic device 10a described with reference to FIG. 12, except that no configuration for polarization is disposed between the second lens part 185 and the lens array 187.

Hereinafter, contents overlapping with the description with reference to FIG. 12 may be omitted or briefly described.

Referring to FIG. 13, the electronic device 10b may include an optical module 18b. The optical module 18b may include the first lens part 183, the second phase retardation part 184, the second lens part 185, and the lens array 187. In other words, the optical module 18b may not include the third phase retardation part 186 of FIG. 12. In an embodiment, the first lens part 183, the second phase retardation part 184, the second lens part 185, and the lens array 187 may be sequentially disposed along the third direction DR3 from the display module 11.

The circularly polarized light that has passed through the second lens part 185 may be incident on the lens array 187. In an embodiment, the light incident on the lens array 187 may be scattered. For example, the light incident on the lens array 187 may be in the right-handed circular polarization state. However, the type of light incident on the lens array 187 according to embodiments of the present disclosure may not be necessarily limited thereto and may also be in the left-handed circular polarization state.

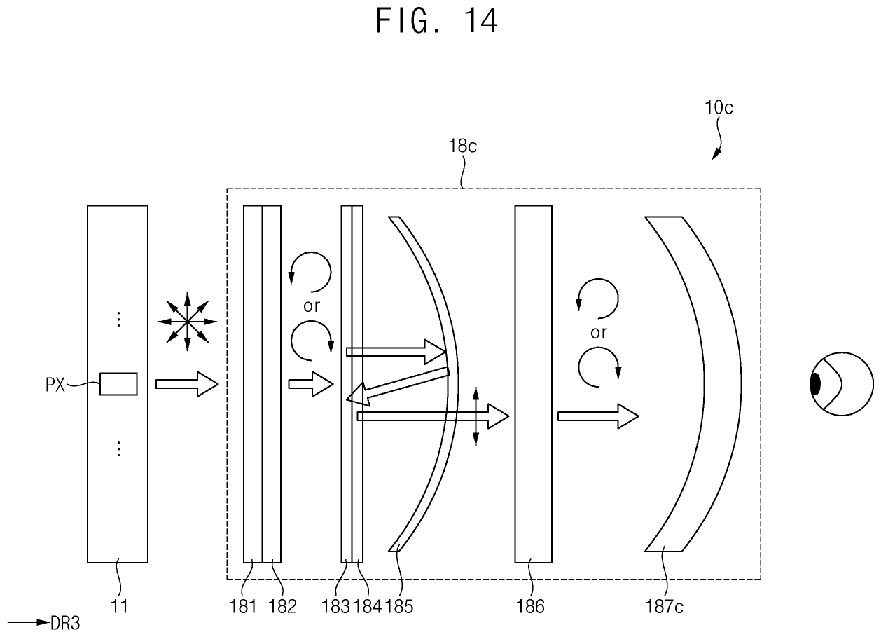

FIG. 14 is a view illustrating still another example of the display module and the optical module included in the electronic device of FIG. 5.

The electronic device 10c described with reference to FIG. 14 may be substantially a same or similar in structure to the electronic device 10 described with reference to FIG. 6, except for the difference in the shape of the lens array 187c.

Hereinafter, contents overlapping with the description with reference to FIG. 6 may be omitted or briefly described.

Referring to FIG. 14, the optical module 18c may include a lens array 187c. The lens array 187c may correspond to the lens array 100 of FIG. 1.

In an embodiment, the lens array 187c may have a concave curved shape with center directed toward the display module 11, in a cross-sectional view. In other words, the lens array 187c may have a convex shape, with the center directed toward the third direction DR3, in a cross-sectional view.

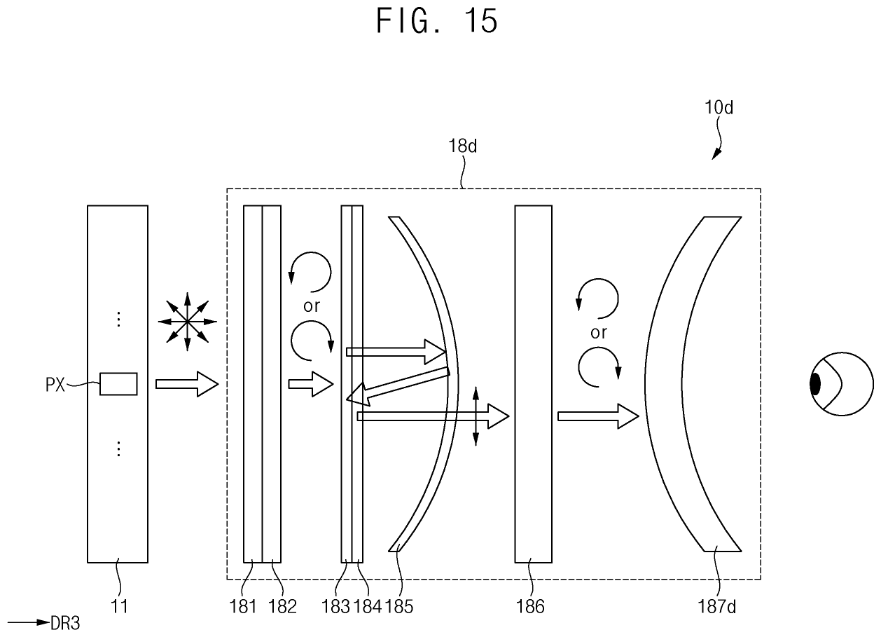

FIG. 15 is a view illustrating still another example of the display module and the optical module included in the electronic device of FIG. 5.

The electronic device 10d described with reference to FIG. 15 may be substantially a same or similar in structure to the electronic device 10 described with reference to FIG. 6, except for the difference in the shape of the lens array 187d.

Hereinafter, contents overlapping with the description with reference to FIG. 6 may be omitted or briefly described.

Referring to FIG. 15, the optical module 18d may include a lens array 187d. The lens array 187d may correspond to the lens array 100 of FIG. 1.

In an embodiment, the lens array 187d may have a convex curved shape with center directed toward the display module 11, in a cross-sectional view. In other words, the lens array 187d may have a concave shape with the center directed toward the third direction DR3, in a cross-sectional view. Accordingly, since the light transmitted through the lens array 187d is scattered relatively widely, the user may secure a relatively wide field of view (FOV). For example, the lens array 187d of FIG. 15 may provide a wider field of view to the user than the lens array 187 of FIG. 6, which has a substantially flat surface.

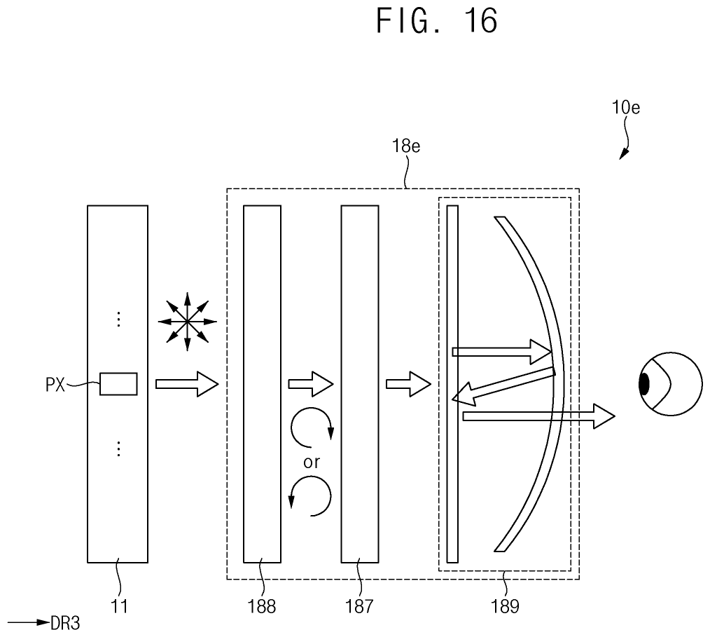

FIG. 16 is a view illustrating still another example of the display module and the optical module included in the electronic device of FIG. 5.

The electronic device 10e described with reference to FIG. 16 may be substantially a same or similar in structure to the electronic device 10a described with reference to FIG. 12, except for the difference in the arrangement of the phase retardation part 188 and the lens structure 189.

Hereinafter, contents overlapping with the description with reference to FIG. 12 may be omitted or briefly described.

Referring to FIG. 16, in an embodiment, the electronic device 10e may include an optical module 18e. The optical module 18e may include a lens array 187, a phase retardation part 188, and a lens structure 189. In an embodiment, the phase retardation part 188, the lens array 187, and the lens structure 189 may be sequentially disposed along a third direction DR3 from the display module 11.

The phase retardation part 188 may correspond to the linear polarization part 181 and the first phase retardation part 182 of FIG. 6. For example, the phase retardation part 188 may polarize light emitted from the plurality of pixels PX into linearly polarized light, and convert the linearly polarized light into circularly polarized light to be incident on the lens array 187.

In an embodiment, the lens array 187 may be disposed between the phase retardation part 188 and the lens structure 189. The circularly polarized light transmitted through the lens array 187 may be incident on the lens structure 189. The lens structure 189 may have a structure substantially a same to that of the first lens part 183, the second phase retardation part 184, and the second lens part 185 of FIG. 6. For example, the lens structure 189 may have a structure in which a beam splitter, a quarter-wave plate, and a polarizing beam splitter are sequentially stacked along the third direction DR3. The electronic device 10e may easily adjust a focal length provided to the user through the lens structure 189.

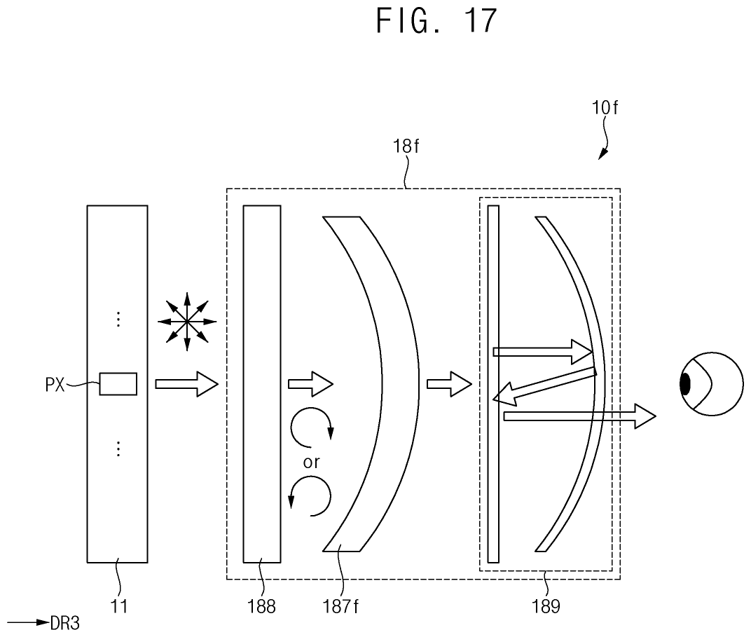

FIG. 17 is a view illustrating still another example of the display module and the optical module included in the electronic device of FIG. 5.

Referring to FIG. 17, the electronic device 10f may be substantially the same as or similar to the structure of the electronic device 10 described with reference to FIG. 6, except that the shape of the lens array 187f is different.

Hereinafter, descriptions that overlap with the description with reference to FIG. 6 may be omitted or briefly described.

Referring to FIG. 17, the optical module 18f may include a lens array 187f. In an embodiment, the lens array 187f may have a concave curved shape toward the display module 11, in a cross-sectional view. In other words, the lens array 187f may have a convex shape toward the third direction DR3 in a cross-sectional view.

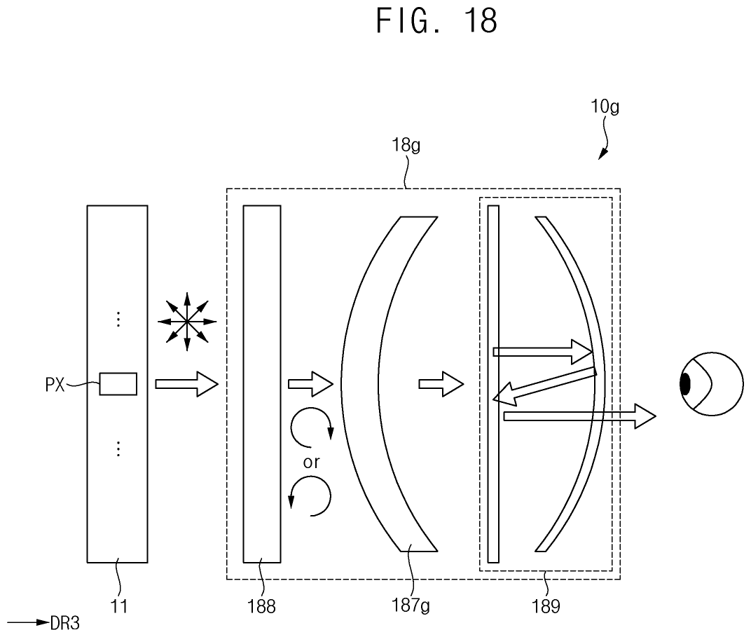

FIG. 18 is a view illustrating still another example of the display module and the optical module included in the electronic device of FIG. 5.

Referring to FIG. 18, the electronic device 10g may be substantially a same as or similar to the structure of the electronic device 10 described with reference to FIG. 6, except that the shape of the lens array 187g is different.

Hereinafter, descriptions that overlap with those provided with reference to FIG. 6 may be omitted or briefly described.

Referring to FIG. 18, the optical module 18g may include a lens array 187g. In an embodiment, the lens array 187g may have a convex curved shape toward the display module 11 in a cross-sectional view. In other words, the lens array 187g may have a concave shape toward the third direction DR3, in a cross-sectional view. Accordingly, since the light transmitted through the lens array 187g is relatively widely diffused, the user may secure a relatively wide field of view.

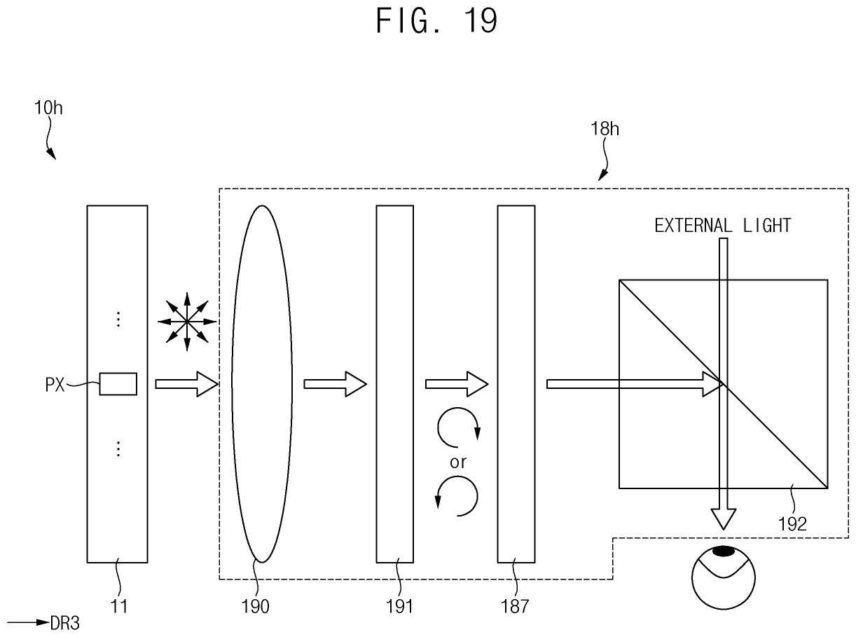

FIG. 19 is a view illustrating still another example of the display module and the optical module included in the electronic device of FIG. 5.

Referring to FIG. 19, the electronic device 10h may include a display module 11 and an optical module. The optical module 18h may include a lens array 187, a convex lens 190, a phase retardation part 191, and a light separation part 192. In an embodiment, the convex lens 190, the phase retardation part 191, the lens array 187, and the light separation part 192 may be sequentially disposed along the third direction DR3 from the display module 11.

The convex lens 190 may be disposed between the display module 11 and the phase retardation part 191.

The phase retardation part 191 may convert the light that has passed through the convex lens 190 into a circularly polarized state. For example, the phase retardation part 191 may correspond to the linear polarization part 181 and the first phase retardation part 182 of FIG. 6. For example, the phase retardation part 191 may polarize the light emitted from the plurality of pixels PX and transmitted through the convex lens 190 into a linearly polarized light, and convert the linearly polarized light into a circularly polarized light to be incident on the lens array 187. The light incident on the lens array 187 may be in a right-handed circular polarization state. However, the type of light incident on the lens array 187 according to the embodiments of the present disclosure may not be necessarily limited thereto and may also be in a left-handed circular polarization state.

In an embodiment, the lens array 187 may be disposed between the phase retardation part 191 and the light separation part 192. The light separation part 192 may deliver the light transmitted through the lens array 187 to the user. The light separation part 192 may deliver external light to the user. In other words, the light separation part 192 may deliver both the light representing the virtual world image and transmitted through the lens array 187 and the external light representing the real world image to the user. Accordingly, the user may simultaneously view the image of the virtual world and the image of the real world.

In an embodiment, the light separation part 192 may be a beam splitter. In an embodiment, the light separation part 192 may be a waveguide that refracts a path of the light emitted from the display module 11. However, the type of light separation part 192 according to the embodiments of the present disclosure may not be necessarily limited thereto, and the light separation part 192 may be any of various types of optical separation devices for simultaneously providing images of the virtual world and the real world.

In an embodiment, the electronic device 10h may be an electronic device for augmented reality (AR), mixed reality (MR), extended reality (XR), or the like, which displays images of the virtual world and the real world simultaneously.

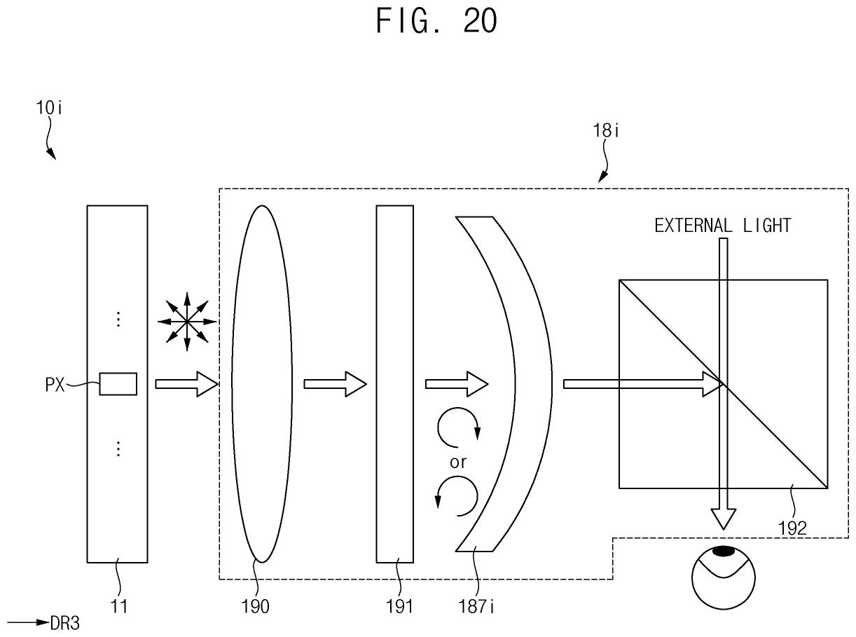

FIG. 20 is a view illustrating still another example of the display module and the optical module included in the electronic device of FIG. 5.

Referring to FIG. 20, the electronic device 10i may be substantially a same as or similar to the structure of the electronic device 10h described with reference to FIG. 19, except that the shape of the lens array 187i is different.

Hereinafter, descriptions that overlap with those provided with reference to FIG. 19 may be omitted or briefly described.

Referring to FIG. 20, the optical module 18i of the electronic device 10i may include a lens array 187i. The lens array 187i may correspond to the lens array 100 of FIG. 1.

In an embodiment, the lens array 187i may have a concave curved shape toward the display module 11, in a cross-sectional view. In other words, the lens array 187i may have a convex shape toward the third direction DR3, in a cross-sectional view.

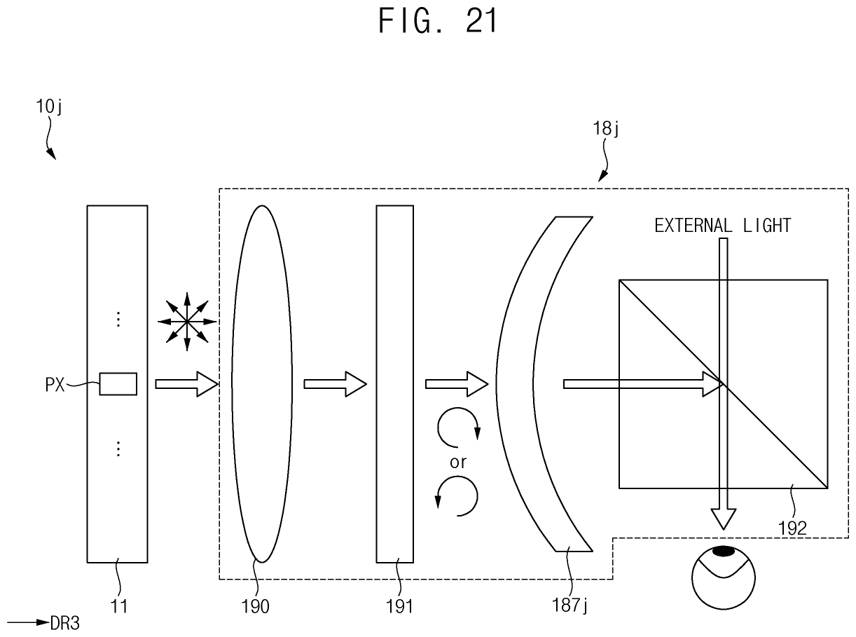

FIG. 21 is a view illustrating still another example of the display module and the optical module included in the electronic device of FIG. 5.

Referring to FIG. 21, the electronic device 10j may be substantially a same as or similar to the structure of the electronic device 10h described with reference to FIG. 19, except that the shape of the lens array 187j is different.

Hereinafter, descriptions that overlap with those provided with reference to FIG. 19 may be omitted or briefly described.

Referring to FIG. 21, the optical module 18j of the electronic device 10j may include a lens array 187j. The lens array 187j may correspond to the lens array 100 of FIG. 1.

In an embodiment, the lens array 187j may have a convex curved shape toward the display module 11, in a cross-sectional view. In other words, the lens array 187j may have a concave shape toward the third direction DR3, in a cross-sectional view. Accordingly, since the light transmitted through the lens array 187j is relatively widely diffused, the user may secure a relatively wide field of view.

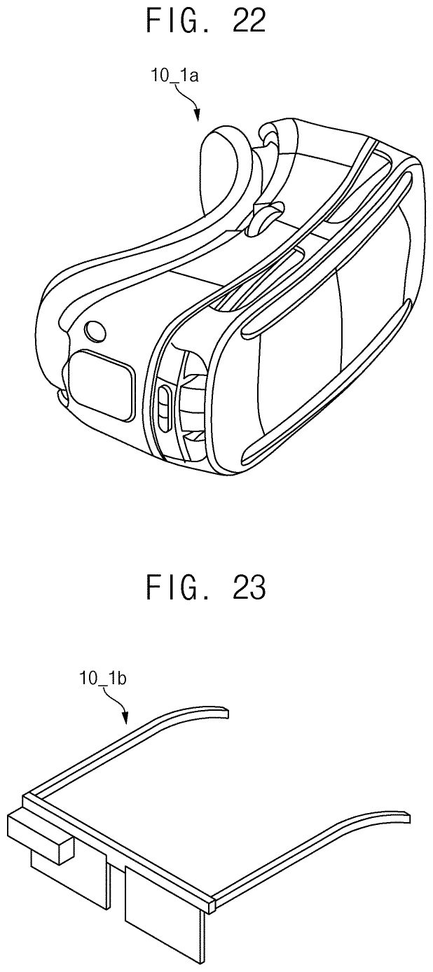

FIG. 22 is a view illustrating an example in which the electronic device of FIG. 5 is implemented. FIG. 23 is a view illustrating another example in which the electronic device of FIG. 5 is implemented.

Referring to FIGS. 22 and 23, an electronic device according to embodiments of the present disclosure (e.g., the electronic device 10 of FIG. 5) may be implemented in the form of a wearable device worn by a user. For example, the electronic device may be implemented in the form of a head mount device (HMD) or smart glasses. Specifically, the head mount device is a device used while being worn on the user's head or face, and may provide a virtual image in three-dimensional space by projecting an image onto the user's retina. In addition, the smart glasses may be worn on the user's ears or head and may provide a virtual image in space through a lens adjacent to the user's eyes. However, implementation form or method of the electronic device according to embodiments of the present disclosure may not be limited to the form or method illustrated in FIGS. 22 and 23. For example, the electronic device may be implemented in the form of a contact lens-type device.

In an embodiment, the electronic device may be used to provide virtual reality (VR), augmented reality (AR), mixed reality (MR) in which virtual reality and augmented reality are combined, or extended reality (XR) in which virtual reality and augmented reality are combined. However, the method of using the electronic device or the method of providing an image or service through the electronic device according to embodiments of the present disclosure may not be necessarily limited thereto.

The modules and devices according to the embodiments may be applied to a display device included in a computer, a notebook, a mobile phone, a smartphone, a smart pad, a PMP, a PDA, an MP3 player, or the like.

Although the modules and devices according to the embodiments have been described with reference to the drawings, the illustrated embodiments are examples, and may be modified and changed by a person having ordinary knowledge in the relevant technical field without departing from the technical spirit described in the following claims.

What is claimed is:

1. An optical module comprising:
a lens array including a plurality of unit lenses each having a lens pattern, wherein a center of lens pattern is spaced apart from a center of each of the unit lenses; and
a polarization controller spaced apart from the lens array in one direction, which converts an incident light into a circular polarization and which guides the circular polarization to the lens array.

2. The optical module of claim 1, wherein the plurality of unit lenses includes:
a first unit lens having a first lens pattern;
a second unit lens located from the first unit lens in a first direction, and having a second lens pattern;
a third unit lens located from the first unit lens in a second direction crossing the first direction, and having a third lens pattern; and
a fourth unit lens located from the second unit lens in the second direction, and having a fourth lens pattern,
wherein a size of a virtual plane having a corner as a center of the first lens pattern, a center of the second lens pattern, a center of the third lens pattern, and a center of the fourth lens pattern is less than a size of a virtual plane having a corner as a center of the first unit lens, a center of the second unit lens, a center of the third unit lens, and a center of the fourth unit lens.

3. The optical module of claim 2, wherein the center of the first lens pattern is spaced apart from the center of the first unit lens in a diagonal direction between the first direction and the second direction,
wherein the center of the second lens pattern is spaced apart from the center of the second unit lens in a diagonal direction between an opposite direction of the first direction and the second direction,
wherein the center of the third lens pattern is spaced apart from the center of the third unit lens in a diagonal direction between the first direction and an opposite direction of the second direction, and
the center of the fourth lens pattern is spaced apart from the center of the fourth unit lens in a diagonal direction between the opposite direction of first direction and the opposite direction of the second direction.

4. The optical module of claim 1, wherein each of the unit lenses is a geometric phase lens.

5. An electronic device comprising:
a display module including a plurality of pixels generates an image by emitting light; and
an optical module which controls the light emitted from the plurality of pixels, and including:
a lens array which refracts the light emitted from the plurality of pixels such that two images generated from two adjacent pixels among the plurality of pixels are partially overlapped and visible to a user; and
a first polarization controller disposed between the display module and the lens array, and polarizes the light emitted from the plurality of pixels.

6. The electronic device of claim 5, wherein the lens array includes a plurality of unit lenses each having a lens pattern, and
a center of the lens pattern is spaced apart from a center of each of the unit lens in a plan view.

7. The electronic device of claim 6, wherein the plurality of unit lenses include:
a first unit lens having a first lens pattern;
a second unit lens located in a first direction from the first unit lens and having a second lens pattern;
a third unit lens located in a second direction crossing the first direction from the first unit lens and having a third lens pattern; and
a fourth unit lens located in the second direction from the second unit lens and having a fourth lens pattern,
wherein the plurality of pixels include:
a first pixel corresponding to the first unit lens;
a second pixel located in the first direction from the first pixel and corresponding to the second unit lens;
a third pixel located in the second direction intersecting the first direction from the first pixel and corresponding to the third unit lens; and
a fourth pixel located in the second direction from the second pixel and corresponding to the fourth unit lens, and
wherein a size of a virtual plane having a corner as a center of the first lens pattern, a center of the second lens pattern, a center of the third lens pattern, and a center of the fourth lens pattern is less than a size of a virtual plane having a corner as a center of the first unit lens, a center of the second unit lens, a center of the third unit lens, and a center of the fourth unit lens.

8. The electronic device of claim 7, wherein at least two images among a first image generated from the first pixel, a second image generated from the second pixel, a third image generated from the third pixel, and a fourth image generated from the fourth pixel are overlapped with each other through the lens array and visible to the user.

9. The electronic device of claim 5, wherein the first polarization controller includes:
a first lens part which converts the light emitted from the plurality of pixels into a linearly polarized state;
a phase retardation part which retards a phase of the linearly polarized light; and
a second lens part which reflects light transmitted through the phase retardation part and having a convex curved shape with a center facing the lens array, in a cross-sectional view.

10. The electronic device of claim 9, wherein the light transmitted through the first polarization controller is in a circularly polarized state.

11. The electronic device of claim 10, wherein the first lens part is a polarizing beam splitter (PBS), and the second lens part is a beam splitter (BS).

12. The electronic device of claim 9, further comprising:
a second polarization controller disposed between the first polarization controller and the lens array,
wherein the second polarization controller which retards a phase of the light transmitted through the first polarization controller by half a wavelength.

13. The electronic device of claim 5, wherein the optical module further includes a lens structure disposed between the first polarization controller and the lens array,
wherein the lens structure includes:
a first lens part on which light transmitted through the first polarization controller is incident;
a phase retardation part which retards a phase of the light transmitted through the first lens part; and
a second lens part which reflects or guide the light transmitted through the phase retardation part and having a convex curved shape with a center facing the lens array, in a cross-sectional view.

14. The electronic device of claim 13, wherein the light transmitted through the lens structure is in a linearly polarized state.

15. The electronic device of claim 14, wherein the optical module further includes a second polarization controller disposed between the lens structure and the lens array,
wherein the first polarization controller converts the light emitted from the display module into a circularly polarized state, and
wherein the second polarization controller converts the linearly polarized light transmitted through the lens structure into a circularly polarized state.

16. The electronic device of claim 15, wherein the second polarization controller retards a phase of the light transmitted through the lens structure by a quarter wavelength.

17. The electronic device of claim 14, wherein the first lens part is a beam splitter (BS), and the second lens part is a polarizing beam splitter (PBS).

18. The electronic device of claim 5, wherein the optical module further includes a light separator which guides the light emitted from the plurality of pixels and transmitted through the lens array to the user,
wherein the light separator guides the representing a virtual world image and transmitted through the lens array and an external light representing a real world image to the user.

19. The electronic device of claim 5, wherein the lens array has a concave curved shape with a center facing the display module, in a cross-sectional view.

20. The electronic device of claim 5, wherein the lens array has a convex curved shape with a center facing the display module, in a cross-sectional view.
